(19) United States
(12) Patent Application Publication
(10) Pub. No.: US 2013/0270758 A1
(43) Pub. Date: Oct. 17, 2013

(54) Wire Holding Device

(71) Applicants: William W. Wittliff, III, Gobles, MI (US); Larry Betcher, Northfield, MN (US); Robert Kochie, Dodge Center, MN (US)

(72) Inventors: William W. Wittliff, III, Gobles, MI (US); Larry Betcher, Northfield, MN (US); Robert Kochie, Dodge Center, MN (US)

(73) Assignee: Service Solutions U.S. LLC, Wilmington, DE (US)

(21) Appl. No.: 13/444,971

(22) Filed: Apr. 12, 2012

(51) Int. Cl. B25B 11/00; B25B 5/16

(52) U.S. Cl. 269/45; 29/559

(57) ABSTRACT

A wire holding device configured to hold two wires together to establishing a connection. The connection may be made through soldering the two wires together. The wire holding device is also configured to be adjustable so that the wires can be held at different angles. The wire holding device can also be used to isolate a wire from a wire loom.

### FIELD OF THE DISCLOSURE

The disclosure generally relates to a wire holding device. More particularly to a wire holding device that is capable of holding a wire at various positions.

### BACKGROUND OF THE DISCLOSURE

Wire repairs in tight spaces are difficult to complete effectively. It takes a high level of skill to create a good solder joint and heat sink the joint. Typically the heat sink starts to sink prior to being placed in position after the solder joint has been created. Butt connectors are easy to use but have a high failure rate especially in areas where the wire moves such as in a vehicle door jamb.

When working in space constrained areas such as vehicle door jambs, under a hood or dash of a vehicle, there is a need to be able to repair wires that are damaged as a result of too much flexion, being pinched, or scraped. These areas are extremely tight and it is difficult to hold two wires together to solder them together. Additionally, there is a risk of damaging other wires while the damaged wire is being repaired.

### SUMMARY OF THE DISCLOSURE

The foregoing needs are met, to a great extent, by the present disclosure, wherein in one aspect, a flexible wire holder is provided that can hold wires together during soldering.

In accordance with certain aspects of the present invention, a flexible holding device that includes a first connector having a first body and a first head, a second connector having a second body and a second head, wherein the second head is positioned within a receiving portion of the first body to form a first shaft, a first holding portion positioned at a first end of the first head and configured to hold a first work piece, a third connector having a third body and a third head, a fourth connector having a fourth body and a fourth head, wherein the fourth head is positioned within a receiving portion of the third body to form a second shaft, a second holding portion positioned at a first end of the third head and configured to hold a second work piece, and a clamping portion, wherein the first and second shafts coupled are coupled to the clamping portion.

In accordance with other aspects of the present disclosure, a flexible holding device that includes a first connector having a first body and a first head, a second connector having a second body and a second head, wherein the second head is positioned within a receiving portion of the first body, a third connector having a third body and a third head, wherein the third head is positioned within a receiving portion of the second body, a fourth connector having a fourth body and a fourth head, wherein the fourth head is positioned within a receiving portion of the third body, a first holding portion positioned at a first end of the first head and configured to hold a first work piece, and a second holding portion positioned at a first end of the fourth body and configured to hold a second work piece, wherein the first, second, third and fourth connectors form a shaft.

In accordance with yet other aspects of the present invention, a method of holding a wire that includes adjusting connectors that form a shaft, wherein the shaft is coupled to clamp, gripping a first wire with a first holding portion and a second wire with second holding portion, and gripping a portion of a vehicle with the clamp.

There has thus been outlined, rather broadly, certain aspects of the invention in order that the detailed description herein may be better understood, and in order that the present contribution to the art may be better appreciated. There are, of course, additional aspects of the invention that will be described below and which will form the subject matter of the claims appended hereto.

In this respect, before explaining at least one embodiment of the invention in detail, it is to be understood that the invention is not limited in its application to the details of the construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a wire holding device according to one embodiment of the invention.

FIG. 2 is a perspective view of a wire holding device according to another embodiment of the invention.

FIG. 3 is a perspective view of a wire holding device holding two wires together according to an embodiment of the invention.

### DETAILED DESCRIPTION OF THE DISCLOSURE

A wire holding device that includes a flexible shaft having a clamping portion at each end according to one embodiment. The clamping portion can be configured to hold two wires that need to be connected together via a connection process, such as being soldered together. The flexible shaft is capable of being configured by the user.

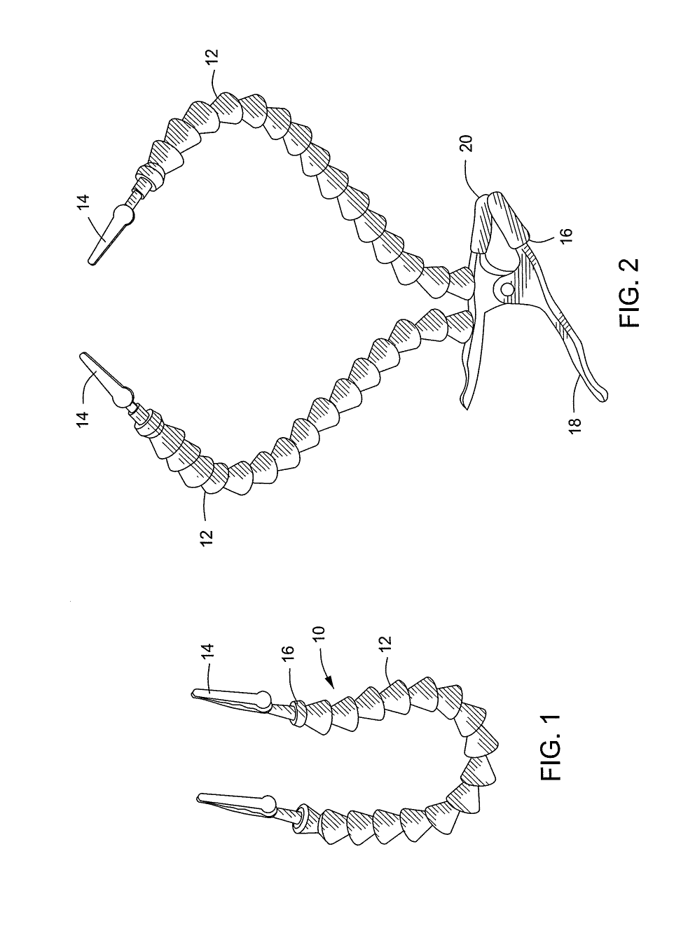

FIG. 1 is a perspective view of a wire holding device 10 according to one embodiment of the invention. The wire holding device 10 includes a flexible shaft 12 having a clamping portion 14 at each end 16. The flexible shaft in bendable so that the shaft can be bent and kept bent at desired angle by the user. This way, the shaft may be shortened or elongated from an attachment point as desired by the user. The length and the angle of the shaft desired by the user will depend on the location where, for example, wires need to be soldered or connected together. In tight spaces such as a door jamb, the ability to extend and shorten the shaft will allow the user to easily connect two wires together. Examples of the length of the shaft in relation to the attachment point can be seen in FIGS. 1-3. Additionally, the shaft 12 can be designed to that it can placed on a surface so that a portion of the shaft acts as a base and another portion can be angled, as needed, to hold a work piece (as described herein) at a different angle.

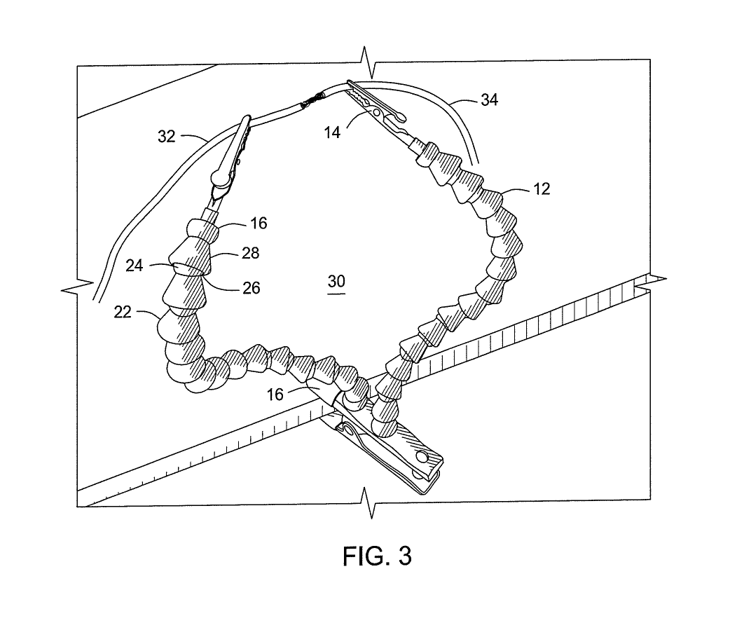

At the ends 16 of the shaft 12 are where the clamping portion 14 are coupled or attached to the shaft 12. The clamping portion 14 are designed to hold a work piece in place. In one embodiment, the work pieces are two wires 32, 34 (FIG. 3) that need to be connected together. In other embodiments, the work piece may be a tubing, papers, such as a manual or a diagram, a light source, such as a flash light, a flame source, such as a lighter to burner, a laser beam source, a heat source, such as a heater, a cold source, a display screen, an electronic device, such as a tablet or a smartphone. The work piece can be anything the user wants held at an angle so that his hands are free to work or be in a relaxed position.

The clamping portion 14 in one embodiment is an alligator clip configured to hold the wire 32, 34. The alligator clip is designed to hold the wire without stripping the insulation therefrom. In other embodiments, the clamping portion may be a quick action clamp that includes adjustable jaws to adjust to fit the work piece, a plier head (needle nose, etc.), T-bar clamp, vice grip, pipe clamps, spring clamps or other similar clamps. The clamp portion can be any device that clamps or hold the work piece and can be configured to fit any sixe work piece. The clamp portion 14 can also be detachable from the shaft 12 so that different types of clamping portion can be used depending on the work piece.

The clamping portion can be connected to the shaft 12 in any number of ways including being welded, screwed, press fitted, glued and the like. In one embodiment, the clamping portion 14 can be coupled to an end 16 and be rotatable around the end 16 so even more flexibility is available to the wire holding device 10.

FIG. 2 is a perspective view of a wire holding device according to another embodiment of the invention. In this embodiment, two shafts 12 are attached to another clamp 16. The two shafts 12 can be attached to the clamp 16 in various ways including soldered, glued, screwed, etc. The attachment may be permanent or can be detachable so that other shaft sizes and length can be attached thereto.

The clamp 16 includes a handle portion 18 and an engagement portion 20. The engagement portion may include an elastomeric cover for better gripping on to a work surface, such as a table. In other embodiments, the clamp portion may be replaced by a vice grip, suction cup or other means that attaches the shaft to a table, work bench or a portion of vehicle.

FIG. 3 is a perspective view of a wire holding device 10 holding two wires 32, 34 together according to an embodiment of the invention. In this embodiment, the wire holding device 10 is clamped to a table or workbench 30 via the clamp 16. The shaft 12 is constructed using individual connector 22 that is coupled to each other. The connector 22 includes a body 28 and a head 24, both of which are generally hollow. The body 28 is generally conically shapes and can be frustoconical shaped. The body 28 includes a receiving portion 26 to receive the head 24 that is frictionally attached to the body. This allows the head to rotate within the receiving portion 26 and the body to rotate in relation to the head. Further, the head is designed so that once it is received within the receiving portion 26, it does not easily separate from the body 28.

In certain embodiments, the body 28 and head 24 may covered with a sheath. The sheath may be made from any material including elastomeric material. The connector 22 may be made from any material including tin, aluminum, steel, alloy and the like.

In operation, the clamp 16 can be used to secure the wire holding device to the table or workbench 30. In other embodiments, the clamp 16 can clamp to a portion of a vehicle such as a door jamb or a hood. The wires 32, 34 can be held securely with holding portion 14 so that the wires can be connected together. The wires 32, 34 can be held at different angles by manipulating the shaft 12 and/or the holding portion 14. The wire may be of various gage such as 18-20 or 8-10 and other gages.

Although a wire holding device is generally is described herein, any the holding device can hold any work piece. Further, the wire holding device can be used to isolate a single wire from a wiring loom to prevent damage to the insulation on the other wires when repairing a broken wire in the wiring loom.

In another embodiment, a conducting material can be threaded the length of the shaft (hollow portion) so that the holding portion can be used to clip to the work piece and provide electricity thereto. For example, one of the shafts in FIG. 2 can be positive and the other shaft can be negative and the holding portion 14 can be a kelvin connector in order to be clamped and to charge a battery or an electrical device. This allows for a battery or an electrical device to be supplied by power then it is located in a difficult place to reach by convention wires.

In yet another embodiment, a fluid conducting material, such as a hose can be threaded the length of the shaft (hollow portion) so that the fluids can be delivered to a device in need of the fluid. Because the shaft is flexible but yet holds its shape when the manipulation is completed, fluid can be delivered to a device that is located where a hose would need to be bend around objects but still retain its shape to deliver the fluid. The shaft also will prevent the hose from being crimped during use so that the fluid deliver is not interrupted.

In still another embodiment, the wire holding device 10 shown in FIG. 1 may have a clamp attached to the shaft 12 similar to what is shown in FIG. 2. This allows more flexibility to the user. Alternatively, the clamp as described in this disclosure may be replaced with a magnet. The magnet may be placed anywhere along the shaft including at an end. The magnet allows the wire holding device to be mated to a surface made of steel, such as in a vehicle.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A flexible holding device, comprising:
a first connector having a first body and a first head;
a second connector having a second body and a second head, wherein the second head is positioned within a receiving portion of the first body to form a first shaft;
a first holding portion positioned at a first end of the first head and configured to hold a first work piece;
a third connector having a third body and a third head;
a fourth connector having a fourth body and a fourth head, wherein the fourth head is positioned within a receiving portion of the third body to form a second shaft;
a second holding portion positioned at a first end of the third head and configured to hold a second work piece; and
a clamping portion, wherein the first and second shafts coupled are coupled to the clamping portion.

2. The device according to claim 1, wherein the first and second work piece is the same or different work pieces.

3. The device according to claim 1, wherein the first and second shafts are configured to be shapeable by a user.

4. The device according to claim 1, wherein the first work piece is a first wire and the second work piece is a second wire.

5. The device according to claim 4, wherein the first and second holding portions are configured to hold the first and second wire together so that they are joined.

6. The device according to claim 1, wherein the first, second, third and fourth connectors have a generally hollow portion.

7. The device according to claim 6, wherein at least one tube runs through the generally hollow portion of the first, second, third or fourth connectors.

8. The device according to claim 6, wherein a first electrical wire runs through the generally hollow portion of the first and second connectors and a second electrical wire runs through the generally hollow portion of the third and fourth connectors.

9. A flexible holding device, comprising:
a first connector having a first body and a first head;
a second connector having a second body and a second head, wherein the second head is positioned within a receiving portion of the first body;
a third connector having a third body and a third head, wherein the third head is positioned within a receiving portion of the second body;
a fourth connector having a fourth body and a fourth head, wherein the fourth head is positioned within a receiving portion of the third body;
a first holding portion positioned at a first end of the first head and configured to hold a first work piece; and
a second holding portion positioned at a first end of the fourth body and configured to hold a second work piece, wherein the first, second, third and fourth connectors form a shaft.

10. The device according to claim 9 further comprising:
a clamping portion, wherein the shaft is coupled to the clamping portion.

11. The device according to claim 9, wherein the first and second work piece is the same or different work pieces.

12. The device according to claim 9, wherein the shaft is configured to be shapeable by a user.

13. The device according to claim 9, wherein the first work piece is a first wire and the second work piece is a second wire.

14. The device according to claim 13, wherein the first and second holding portions are configured to hold the first and second wire together so that they are joined.

15. The device according to claim 9, wherein the first, second, third and fourth connectors have a generally hollow portion.

16. The device according to claim 15, wherein at least one tube runs through the generally hollow portion of the first, second, third or fourth connectors.

17. The device according to claim 15, wherein a first electrical wire runs through the generally hollow portion of the first and second connectors and a second electrical wire runs through the generally hollow portion of the third and fourth connectors.

18. A method of holding a wire, comprising the steps of:
adjusting connectors that form a shaft, wherein the shaft is coupled to clamp;
gripping a first wire with a first holding portion and a second wire with second holding portion; and
gripping a portion of a vehicle with the clamp.

19. The method of claim 18, wherein the adjusting step further includes adjusting to make the two wires connect together.

20. The method of claim 18, wherein the first and second holding portion is adjustable in relation to the shaft.
